(19) United States
(12) Patent Application Publication
(10) Pub. No.: US 2026/0296654 A1
(43) Pub. Date: Oct. 1, 2026

(54) ELECTRICAL DISTRIBUTION METHOD AND SYSTEM, CONFIGURED TO SUPPLY ELECTRIC MOTORS OF AN AIRCRAFT FROM AT LEAST ONE ELECTRICAL SOURCE

(71) Applicant: SAFRAN ELECTRICAL & POWER, BLAGNAC (FR)

(72) Inventors: Quentin CORNU, MOISSY-CRAMAYEL (FR); Olivier DESHAYES, MOISSY-CRAMAYEL (FR)

(21) Appl. No.: 18/881,344

(22) PCT Filed: Jul. 1, 2023
(86) PCT No.: PCT/EP2023/068132

§ 371 Date: Jan. 6, 2025

(30) Foreign Application Priority Data
Jul. 8, 2022 (FR) FR2207061

(51) Int. Cl. B64D 27/34; H02H 9/02; H02J 3/00

(52) U.S. Cl. CPC B64D 27/34; H02H 9/02; H02J 3/00; B64D 2221/00

(57) ABSTRACT

An electrical distribution system configured to supply at least a first electric motor and a second electric motor from at least one electrical source. The electrical distribution system including a switch connected to the electrical source by an electrical source line and to each electric motor by an electrical load line, a circuit-breaking device, configured to open the electrical source line after a predetermined time delay in the event of the presence of a short-circuit current, and a current limiter configured to, in the event of the presence of a short-circuit current, allow a limited current to flow through the switch for a limiting period greater than the predetermined time delay.

### TECHNICAL FIELD

The present invention relates to an electrical distribution system configured to supply a plurality of electric propulsion motors for an aircraft from at least one electrical source.

The climate change is a major concern for many legislative and regulatory members around the world. Various restrictions on carbon emissions have been, are being or will be adopted by various states. In particular, an ambitious standard applies both to new types of aircrafts and to those already in circulation, requiring the implementation of technological solutions so as to bring them into line with current regulations. For several years now, the civil aviation has been working to help combat climate change.

The technological research efforts have already led to significant improvements in the environmental performance of the aircrafts. The Applicant takes into account the impacting factors in all phases of design and development to obtain aeronautical elements and products that consume less energy, are more environmentally friendly and whose integration and use in civil aviation have moderate environmental consequences with the aim of improving the energy efficiency of the aircrafts.

Consequently, the Applicant is constantly working to reduce its negative impact on the climate by employing methods and using development and manufacturing methods that are virtuous and minimize greenhouse gas emissions to the minimum possible in order to reduce the environmental footprint of its business.

This sustained research and development work covers both new generations of aircraft motors and the use of electrical technologies for propulsion.

In a known way, with reference to FIG. 1, an aircraft may comprise several electric motors M11-M14 for allowing its propulsion, which are supplied by two electrical batteries B11, B12 via an electrical distribution system 100. In this example, the electrical distribution system 100 comprises a first electrical switch C11 connected, on the one hand, to the first electrical battery B11 and, on the other hand, to two propulsion motors M11, M12. The electrical distribution system 100 also comprises a second electrical switch C12 connected, on the one hand, to the second electrical battery B12 and, on the other hand, to two other propulsion motors M13, M14.

In order to ensure the supply to the electric motors M11-M14 in the event of an isolated fault, it has been proposed to use an electrical distribution system 100 with a so-called “segregated” architecture, i.e. allowing the electrical batteries B11, B12 to take over from each other in the event of a fault. The first switch C11 is connected to the second electrical battery B12 by a first reconfiguration line R1. Similarly, the second switch C12 is connected to the first electrical battery B11 by a second reconfiguration line R2. The electrical reconfiguration lines R1, R2 are preferably unidirectional and only allow a current to flow in one direction so as to avoid simultaneous faults to appear. Each reconfiguration line R1, R2 comprises one or more reconfiguration switches IR1, IR2 so as to supply the switches C11, C12 if an electrical battery B11, B12 is unavailable.

Short-circuits may occur in the electrical distribution system 100. When a short-circuit occurs, the power supply from the electrical sources B11, B12 is cut off immediately so as to protect the electrical distribution system 100. For an electrical distribution system 100 comprising electrical sources B11, B12 with high voltages, it is not possible to use traditional safety equipment. As shown in FIG. 2, the short-circuit current Icc may reach several tens of thousands of volts in a very short time. The higher the current flowing through an electrical line, the more difficult it is to open the electrical line.

In order to eliminate this disadvantage, with reference to FIG. 3, it has been proposed to provide different protection members in the electrical distribution system 100. For the sake of clarity, only a portion of the electrical distribution system 100 relating to the first electrical battery B11 is shown in FIG. 3.

In particular, a source switch 102 is fitted on an electrical source line LS connecting the first electrical battery B11 to the first switch C11. Similarly, a load switch 141, 142 is fitted on each electrical load line LC1, LC2 connecting the first switch C1 to its associated propulsion motors M11, M12. In a known way, the electrical distribution system 100 also comprises a monitoring device 105 comprising measurement sensors and a computer in order to measure the electrical parameters of the electrical distribution system 100 and to deduce the control of the switches 102, 141, 142 in the event of a short-circuit as will be presented below.

In nominal mode operation, the switches 102, 141, 142 are closed. When a short-circuit is detected, the monitoring device 105 immediately controls the opening of the source switch 102 so as to limit the rise in the short-circuit current. This allows to avoid having to switch off a very high short-circuit current, which could cause damage. The first electrical battery B11 is thus isolated.

For example, if a short-circuit is present on the first electrical load line LC1 of the first electric motor M11, the monitoring device 105 controls the opening of the load switch 141 so as to isolate the first electrical load line LC1. The source switch 102 may then be closed again to supply the switch C11, which then supplies only the second electric motor M12. The electrical distribution system 100 is then in degraded mode The transition between a nominal mode of the electrical distribution system 100 and a degraded mode is thus achieved in several steps: a first step of isolating the first electrical battery B11 so as to stop the supply to the electrical distribution system 100, a second step of isolating the electrical line presenting a fault and a third step of re-supplying the electrical distribution system 100 by the first electrical battery B11.

In practice, the first step of isolating the first electrical battery B11 is disadvantageous as the electric motors M11, M12 are no longer supplied. The result is a loss of supply to the electric motors M11, M12 for a very short time, less than 1 second, which is likely to generate a jerk in the aircraft's propulsion, which is a disadvantage. The first switch C11 generally comprises electrical capacitors that need to be charged so as to allow the first switch C11 to perform its function. Following the isolation of the first electrical battery B11, the electrical capacities of the first switch C11 are discharged.

In addition, a source switch 102 is generally in the form of a Solid State Power Controller (SSPC) switch, as it allows to open very quickly when a short-circuit is detected. Such a source switch 102 is expensive and complex to integrate into an electrical distribution system 100, which presents another disadvantage.

The prior art patent application W02021210124 teaches a power supply system with a current limiting device.

### PRESENTATION OF THE INVENTION

The invention relates to an electrical distribution system configured to supply at least a first electric motor and a second electric motor from at least one electrical source, the electric motors being aircraft propulsion motors, the electrical distribution system comprising:
At least one switch configured, on the one hand, to be connected to the electrical source by an electrical source line and, on the other hand, to be connected to each electric motor via an electrical load line,
at least one circuit-breaking device, mounted on the electrical source line, configured to open the electrical source line after a predetermined time delay in the event of the presence of a short-circuit current.
at least one current limiter, mounted on the electrical source line between the circuit-breaking device and the switch, configured so as, in the presence of a short-circuit current, to allow a limited current to flow through the switch for a limiting period greater than the predetermined time delay.

Thanks to the invention, the electrical distribution system is always supplied during the limiting period so that the short-circuit may be isolated without stopping the switch and the electric motors. As a result, a short-circuit may be isolated without causing a jerk in the aircraft's propulsion, which is advantageous. The presence of a circuit-breaking device allows to protect the electrical distribution system before the limiting period expires.

Preferably, the current limiter is configured to dissipate, during the limiting period, at least a power of 300 kW, preferably at least a power of 400 kW. Such a current limiter allows to provide sufficient time to isolate the short-circuit. Preferably, the limiting period is greater than 100 ms.

According to a preferred aspect, the predetermined time delay is between 100 ms and 300 ms. Such a time delay allows to provide sufficient time to isolate the short-circuit while allowing a short-circuit to be cut off at a compatible short-circuit current value.

Preferably, the distribution system comprises at least one load switch, mounted on an electrical load line. Preferably, a load switch is fitted to each electrical load line.

Preferably, the load switch is configured to pass automatically to the open state when a load current greater than a predetermined current threshold flows in the electrical load line for a predetermined flow time. In this way, the load switch fulfils a fuse function so as to isolate a short-circuit.

Preferably, the predetermined flow time is less than the predetermined time delay. In this way, the short-circuit is isolated before the power supply is cut-off, thus avoiding such a circuit breaking.

Preferably, the current threshold is less than the limited current so as to allow the load switch to fulfil its function when limiting the current.

Preferably, the load switch is a thermal switch

The invention also relates to an electrical architecture comprising at least one electrical source, at least one first electric motor and a second electric motor, the electric motors being aircraft propulsion motors, the architecture comprising an electrical distribution system as previously presented to supply the electric motors from the electrical source.

The invention also relates to an aircraft comprising an architecture as presented above.

The invention also relates to an electrical distribution method in an electrical distribution system supplying at least a first electric motor and a second electric motor from at least one electrical source, the electric motors being aircraft propulsion motors, the electrical distribution system comprising at least one switch connected, on the one hand, to the electrical source via an electrical source line and, on the other hand, to each electric motor via an electrical load line, the method comprising steps consisting in:
if a short-circuit current is present, limiting the current to a limited current value in the switch for a limiting period and
opening the electrical source line after a predetermined time delay if a short-circuit current is present, the predetermined time delay being less than the limiting period.

Preferably, the distribution method comprises a step consisting in automatically opening an electrical load line when a load current greater than a predetermined current threshold flows in the electrical load line for a predetermined flow time less than the predetermined time delay.

Preferably, the distribution method comprises a step consisting in inhibiting the current limitation in the switch following the disappearance of the short-circuit current. This allows to stop the time delay and not open the electrical source line.

### PRESENTATION OF FIGURES

The invention will be better understood on reading the following description, given by way of example, with reference to the following figures, given by way of non-limiting examples, wherein identical references are given to similar objects.

FIG. 1 is a schematic representation of a prior art electrical distribution system.

FIG. 2 is a schematic representation of the evolution of the short-circuit current in an electrical distribution system.

FIG. 3 is a close-up schematic representation of a portion of the electrical distribution system shown in FIG. 1.

FIG. 4 is a schematic representation of an electrical distribution system according to one embodiment of the invention.

FIG. 5, FIG. 6, FIG. 7 and FIG. 8 are schematic representations of the currents flowing in the electrical distribution system of FIG. 4 for a localized short-circuit on an electrical load line.

FIG. 9 and FIG. 10 are schematic representations of the currents flowing in the electrical distribution system of FIG. 4 for a localized short-circuit on an electrical source line.

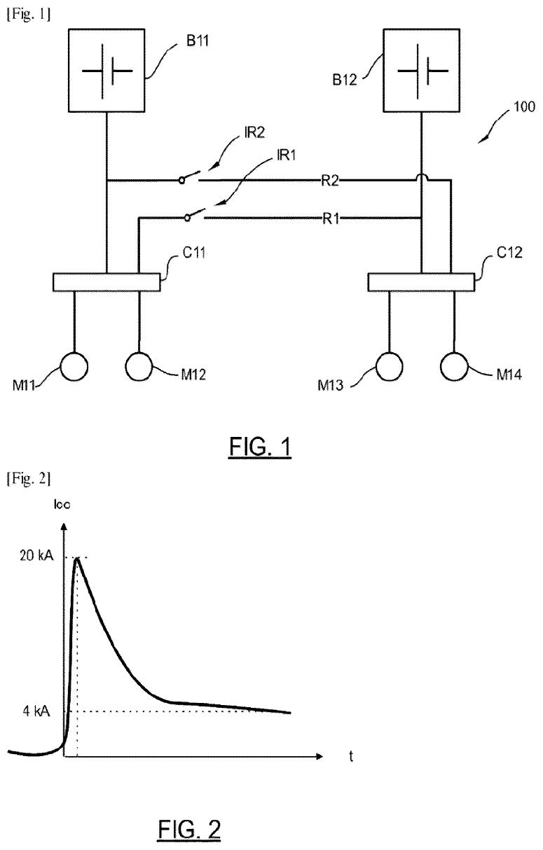

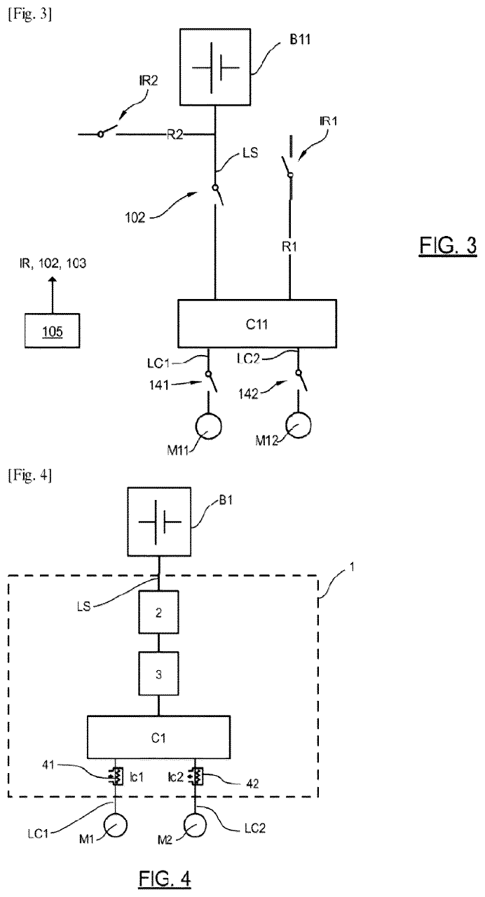

It should be noted that the figures set out the invention in detail in order to implement the invention, said figures of course being able to be used to better define the invention if necessary.

### DETAILED DESCRIPTION OF THE INVENTION

We will now present an aircraft comprising an electrical architecture so as to ensure the propulsion of the aircraft.

With reference to FIG. 4, an electrical architecture is shown comprising a first electric motor M1 and a second electric motor M2 for propelling the aircraft. However, the invention is applicable to more than two electric motors M1, M2, in particular four.

In order to supply the electric motors M1, M2, the electrical architecture comprises one or more electrical sources B1, in particular electrical batteries. In this example, only a single electrical source B1 is shown for the sake of clarity.

According to the invention, the electrical architecture comprises an electrical distribution system 1 configured to transfer electrical power between the electrical source or sources B1 and the electric motors M1, M2. This energy transfer is preferably bidirectional to allow the electrical sources B1 to be recharged via the electric motors M1, M2 (generator operation).

In this example, with reference to FIG. 4, the electrical distribution system 1 comprises a first electrical switch C1 connected, on the one hand, to the electrical source B1 and, on the other hand, to two electric motors M1, M2. This allows to form a supply channel. For the sake of clarity, a single supply channel is shown, but it goes without saying that there could be more.

Preferably, the electrical distribution system 1 comprises “segregated” supply channels, i.e. allowing the electrical sources to take over from each other in the event of a fault. Preferably, the electrical distribution system 1 comprises reconfiguration lines as introduced in the preamble.

According to the invention, with reference to FIG. 4, the electrical distribution system 1 comprises a switch C1 connected, on the one hand, to the electrical source B1 by an electrical source line LS and, on the other hand, to each electric motor M1, M2 by an electrical load line LC1, LC2. In this example, the switch C1 is in the form of a power supply bus, preferably a high-voltage bus.

According to the invention, the electrical distribution system 1 comprises a circuit-breaking device 2, mounted on the electrical source line LS, configured to open the electrical source line LS after a predetermined time delay D2 in the event of the presence of a short-circuit current Icc.

The circuit-breaking device 2 is preferably in the form of a contactor, preferably electromagnetic, combined with a current sensor and a timer. The predetermined time delay D2 depends on the current that may be cut. In this example, the predetermined time delay D2 is between 100 and 300 ms to achieve a circuit breaking of up to 1500 A.

The circuit-breaking device 2 allows to cut off the supply to the source line LS if the short-circuit has not been processed within the predetermined time delay D2. This allows to prevent a damage to the electrical distribution system 1, which could lead to a fire.

As illustrated in FIG. 4, the electrical distribution system 1 comprises a current limiter 3, mounted on the electrical source line LS between the circuit-breaking device 2 and the switch C1. The current limiter 3 is configured so that, if a short-circuit current Icc is present, it allows a limited current Ilim to flow through the switch C1 for a limiting period D3. Such a current limiter 3 advantageously allows the switch C1 to be supplied in the event of a short-circuit with a limiting current Ilim permissible by the switch C1.

In this example, the value of the limited current Ilim is between 400 A and 700 A, preferably between 500 A and 600 A. The short-circuit current Icc may be of the order of 4000 A. This value is determined, in particular, as a function of the nature of the load switches 41, 42, as will be shown later.

The current limiter 3 is configured to dissipate electrical power, in particular in the form of heat, during the limiting period D3. Preferably, the current limiter 3 is configured to dissipate, during the limiting period D3, a power greater than 300 kW. greater than 400 kW.

The limiting period D3 is preferably greater than 100 ms so as to allow the electrical distribution system 1 to switch to degrade mode as described below. Preferably, the limiting period D3 is between 500 ms and 1000 ms.

Preferably, the current limiter 3 is in the form of a semiconductor current limiter, a thermistor, a resistive superconductor, a parallel inductance superconductor or the like.

According to the invention, the limiting period D3 is greater than the predetermined time delay D2 (D3>D2) so as to allow the circuit-breaking device 2 to cut the power supply to the electrical source B1 if no degraded mode is possible.

The activation of the circuit-breaking device 2 before the end of the limiting period D3 advantageously protects the switch C1 and the electric motors M1, M2 against a high-value short-circuit current Icc.

Still referring to FIG. 4, a first load switch 41 and a second load switch 42 are mounted respectively on the first electrical load line LC1 and on the second electrical load line LC2.

However, the invention also applies to a load switch 41, 42 mounted on a single electrical load line LC1, LC2.

In this example, each load switch 41, 42 is configured to switch automatically to the open state when a load current Ic1, Ic2 greater than a predetermined current threshold Iseuil flows in the electrical load line LC1, LC2 for a predetermined flow time D4.

In this way, the load switch 41, 42 fulfils a fuse function which opens the electrical load line LC1, LC2 when the current flowing (load current Ic1, Ic2) is too high, i.e. greater than the predetermined current threshold Iseuil.

Advantageously, the predetermined flow time D4 is less than the predetermined time delay D2. In other words, each load switch 41, 42 has enough time to fulfil its fuse function before the circuit-breaking device 2 stops the power supply at the end of the predetermined time delay D2.

The predetermined flow time D4 must be long enough to avoid unwanted circuit-breaking and short enough to avoid using a current limiter 3 with a long limiting period D3 and a circuit-breaking device 2 which has to disconnect high currents, which would increase the cost and the overall dimension of the electrical distribution system 1. This gives us the following relationship: D4<D2<D3. Preferably, the predetermined flow time D4 is between 10 and 50 ms.

Advantageously, the current threshold Iseuil is lower than the current limited Ilim by the current limiter 3 so as to allow the load switch 41, 42 to fulfil its fuse function when the current limiter 3 is activated in the presence of a short-circuit current Icc.

Preferably, each load switch 41, 42 is a thermal switch or pyroswitch.

### Example of Implementation 1

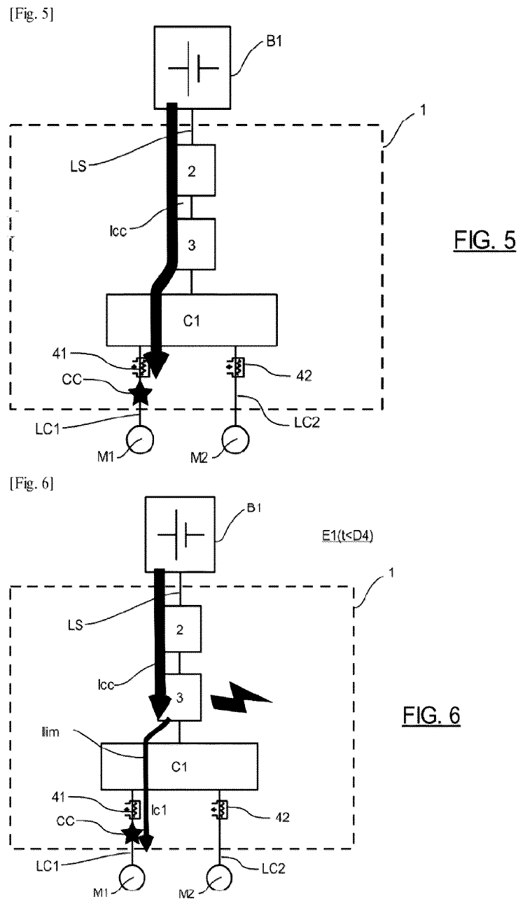

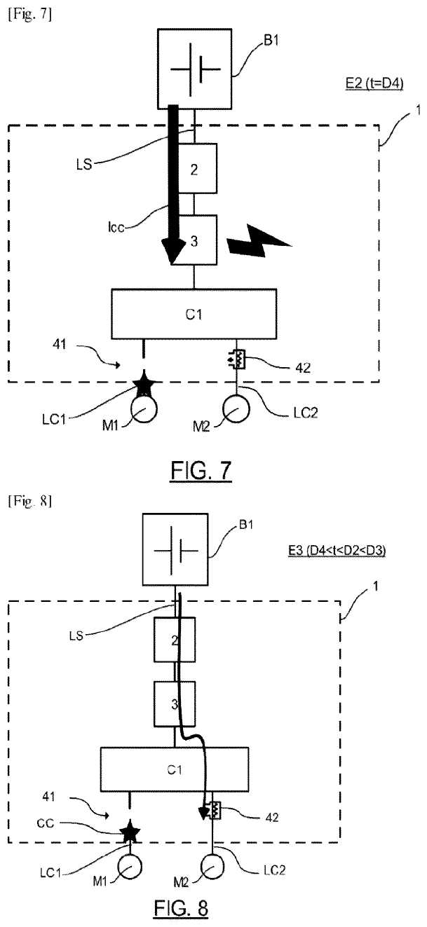

### Short-Circuit CC on the First Electrical Load Line LC1 (FIGS. 5 to 8)

A first example of the implementation of an electrical distribution method will be presented for an electrical distribution system 1 as shown in FIG. 4.

In this example, with reference to FIG. 5, a short-circuit CC is present on the first electrical load line LC1 between the switch C1 and the first electric motor M1. When the short-circuit CC occurs, a short-circuit current Icc flows between the electrical source B1 and the short-circuit CC. No electrical current flows on the second electrical load line LC2, the current being conducted to the short-circuit CC.

With reference to FIG. 6, the method comprises a step consisting in, in the presence of a short-circuit current Icc, limiting E1 the current to a limited current value Ilim in the switch 3 during the limiting period D3. The current limiter 3 reduces the short-circuit current Icc. As shown in FIG. 6, the load current Ici corresponds to the limited current Ilim in the first electrical load line LC1.

With reference to FIG. 7, the method comprises a step consisting in automatically opening E2 the first electrical load line LC1 when the load current Ic1 is greater than the predetermined current threshold Iseuil during the predetermined flow time D4. As the value of the limited current Ilim is greater than the predetermined current threshold Iseuil, the load switch 41 opens the first electrical load line LC1 at the end of the predetermined flow time D4. In this way, the first load switch 41 fulfils its function as a fuse and isolates the first electric motor M1, which may no longer be supplied.

With reference to FIG. 8, following the isolation of the short-circuit CC, there is no longer any short-circuit current Icc and the method comprises a step E3 consisting in inhibiting the limitation. The current limiter 3 normally supplies the second electric motor M2. The distribution system 3 is therefore in degraded mode. In contrast to the prior art, the power supply to the switch C1 was maintained by the current limiter 3, which prevented its capacities from being discharged. The second motor M2 continues to contribute to the propulsion without any jerk perceptible to the pilot or the passengers.

This example of implementation is particularly advantageous in the event of a stealth short-circuit which disappears before the end of the predetermined flow time D4. Thanks to the current limiter 3, the electric motors M1, M2 continue to contribute to the propulsion without any jerk perceptible to the pilot or the passengers.

### Example of Implementation 2

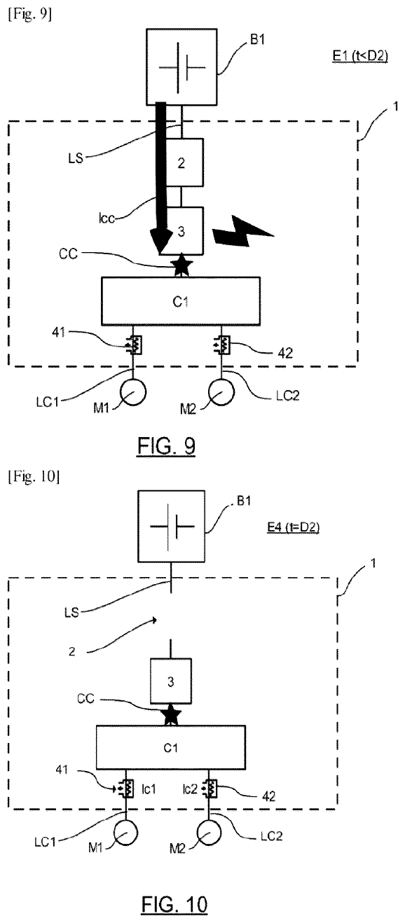

### Short-Circuit CC on the Source Line LS (FIGS. 9 to 10)

A second example of implementation of an electrical distribution method will be presented for an electrical distribution system 1 as shown in FIG. 4.

In this example, with reference to FIG. 9, a short-circuit CC is present on the first electrical source line LS between the current limiter LS and the switch C1. When the short-circuit CC occurs, a short-circuit current Icc flows between the electrical source B1 and the short-circuit CC. No electrical current flows on the electrical load lines LC1, LC2.

Still referring to FIG. 9, the method comprises a step consisting in, if a short-circuit current Icc is present, limiting E1 the current to a limited current value Ilim in the switch 3 during the limiting period D3. The current limiter 3 reduces the short-circuit current Icc.

This state means that no electrical current is flowing on the electrical load lines LC1, LC2. The load switches 41, 42 remain closed.

With reference to FIG. 10, the method comprises a step consisting in opening E4 the electrical source line LS after the predetermined time delay D2. The circuit-breaking device 2 opens the electrical source line LS since a short-circuit current Icc is still present so as to protect the switch C1 before the end of the limiting period D3. The predetermined time delay D2 allows the power supply to be cut off until the short-circuit current Icc is too high.

Thanks to the invention, the electrical distribution system 1 may be switched to a degraded mode without causing jerks during the aircraft propulsion. In addition, the judicious setting of current values, threshold values and the various durations D2, D3, D4 allows very reactive tripping in the event of a short-circuit. The safety and the availability of the propulsion systems have been further enhanced.

1. An electrical distribution system configured to supply at least a first electric motor and a second electric motor from at least one electrical source, wherein the electric motors are aircraft propulsion motors, the electrical distribution system comprising:
at least one switch configured to be connected to the electrical source by an electrical source line and to be connected to each electric motor via an electrical load line,
at least one circuit-breaking device, mounted on the electrical source line, configured to open the electrical source line after a predetermined time delay in the event of the presence of a short-circuit current,
at least one current limiter, mounted on the electrical source line between the circuit-breaking device and the switch, configured so as, in the presence of a short-circuit current, to allow a limited current to flow through the switch for a limiting period greater than the predetermined time delay, the value of the limiting current being between 400 A and 700 A, the limiting period being greater than 100 ms.

2. The electrical distribution system according to claim 1, wherein the current limiter is configured to dissipate, during the limiting period, at least a power of 300 KW.

3. The electrical distribution system according to claim 1, wherein the predetermined time delay is between 100 ms and 300 ms.

4. The electrical distribution system according to claim 1, further comprising at least one load switch, mounted on an electrical load line.

5. The electrical distribution system according to claim 4, wherein the load switch is configured to pass automatically to the open state when a load current greater than a predetermined current threshold flows in the electrical load line for a predetermined flow time.

6. The electrical distribution system of claim 5, wherein the predetermined flow time is less than the predetermined time delay.

7. The electrical distribution system according to claim 4, wherein the current threshold is less than the limited current.

8. An electrical architecture comprising at least one electrical source, at least one first electric motor and a second electric motor, wherein the electric motors are aircraft propulsion motors, the architecture comprising an electrical distribution system according to claim 1 to supply the electric motors from the electrical source.

9. An electrical distribution method in an electrical distribution system supplying at least a first electric motor and a second electric motor from at least one electrical source, the electric motors being aircraft propulsion motors, the electrical distribution system comprising at least one switch connected to the electrical source via an electrical source line and to each electric motor via an electrical load line, the method comprising:
limiting the current to a limited current value in the switch for a limiting period when a short-circuit current is present, the limited current value being between 400 A and 700 A, the limiting period being greater than 100 ms; and
opening the electrical source line after a predetermined time delay if a short-circuit current is present, the predetermined time delay being less than the limiting period.

10. The electrical distribution method according to claim 9, further comprising:
automatically opening an electrical load line, when a load current greater than a predetermined current threshold flows in the electrical load line for a predetermined flow time less than the predetermined time delay.

11. The electrical distribution method according to claim 10, further comprising:
inhibiting the current limitation in the switch following the disappearance of the short-circuit current.

12. The electrical distribution system according to claim 2, wherein the current limiter is configured to dissipate, during the limiting period, at least a power of, at least a power of 400 kW.
